(19) United States
(12) Patent Application Publication
(10) Pub. No.: US 2020/0139689 A1
(43) Pub. Date: May 7, 2020

(54) METALLIZED FABRIC THAT ENHANCES THERMAL INSULATION

(71) Applicant: The North Face Apparel Corp., Wilmington, DE (US)

(72) Inventors: Cindy Y. Lau, Alameda, CA (US); John Ly, Oakland, CA (US); Kirk Michael Mayer, San Francisco, CA (US); Abolfazl Aghanouri, Richmond, CA (US)

(21) Appl. No.: 16/673,274

(22) Filed: Nov. 4, 2019

Related U.S. Application Data
(60) Provisional application No. 62/755,116, filed on Nov. 2, 2018.

(51) Int. Cl. B32B 27/12; B32B 5/02

(52) U.S. Cl. CPC B32B 27/12; B32B 5/024; D10B 2403/03; D10B 2401/04; D03D 2700/80

(57) ABSTRACT

Disclosed is a textile comprising a woven fabric and a layer of a low emissivity material disposed on the woven fabric, wherein the layer of low emissivity material is vapor deposited. The woven fabric has a yarn size of no greater than 30D and a weight no greater than 55 gsm. At least one coating layer vapor may be deposited adjacent the low emissivity layer. The woven fabric may comprise one or more of a nylon or a polyester. The textile may exhibit an increase in insulation ability of at least 10% compared to a substantially similar woven fabric in the absence of the low emissivity layer when tested together with a fibrous sheet insulation and another untreated woven fabric in accordance with ASTM-F1868 Part A.

### CROSS-REFERENCE TO RELATED APPLICATION

This application claims the benefit of U.S. Provisional Application No. 62/755,116 filed Nov. 2, 2018, the disclosure of which is hereby incorporated herein by this reference in its entirety.

### FIELD OF THE DISCLOSURE

The present disclosure relates to woven fabrics, particularly woven fabrics having a low emissivity material deposited thereon to provide a thermally insulating functionality to the woven fabric.

### BACKGROUND OF THE DISCLOSURE

Textiles have been functionalized in a number of ways to impart certain properties or to enhance/support existing properties of the textile. Functionalization of these materials may refer to the addition of additives or other agents to a surface of the textile to provide particular functional properties. These can include functionalization for waterproofing/water resistance, cooling, and antibacterial functionalities. Metal coated fabrics have been developed for imparting certain properties to a garment. It is desirable that any functionalization does not negatively affect the structural integrity or unique properties of the base fabric. For example, added functionalities may be configured so as to not affect porosity of the material.

There remains a need for improvements of functionalized fabrics.

### SUMMARY

Aspects of the disclosure relate to a textile comprising: a woven fabric comprising one or more of a nylon or a polyester, wherein the woven fabric has a yarn size of no greater than 30D and a weight no greater than 40 gsm; a layer of a low emissivity material disposed on the woven fabric, wherein the layer of low emissivity material is vapor deposited; and at least one coating layer vapor deposited adjacent the low emissivity layer. The textile may exhibit an increase in insulation ability of at least 10% compared to a substantially similar woven fabric in the absence of the low emissivity layer when tested in an insulation package in accordance with ASTM-F1868 Part A.

Aspects of the disclosure further relate to methods for forming a textile comprising: a woven fabric comprising one or more of a nylon or a polyester, wherein the woven fabric has a yarn size of no greater than 30D and a weight no greater than 40 gsm; a layer of a low emissivity material disposed on the woven fabric, wherein the layer of low emissivity material is vapor deposited; and at least one coating layer vapor deposited adjacent the low emissivity layer. The textile may exhibit an increase in insulation ability of at least 10% (e.g., 10-25%; 25%; 10% after 10 washes; etc.) compared to a substantially similar woven fabric in the absence of the low emissivity layer when tested in an insulation package in accordance with ASTM-F1868 Part A.

Further aspects relate to articles, such as garments, comprising the disclosed textile.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example of a cross-section profile of a woven fabric.

FIG. 2 shows a diagram depicting surface profile characteristics with a comparison of surface waviness and surface roughness.

FIG. 3 shows a graphical representation of the percent difference in insulation as a function of surface waviness of varying woven fabrics including the disclosed woven fabric.

FIG. 4 illustrates example test data for treated and untreated materials in accordance with the present disclosure.

FIG. 5 illustrates example test data for treated and untreated materials in accordance with the present disclosure.

FIG. 6 illustrates example test data for treated and untreated materials in accordance with the present disclosure.

FIG. 7A is a top perspective view of a composite fabric according to an aspect of the disclosure.

FIG. 7B is a view of one side of the composite fabric of FIG. 7A.

FIG. 7C is a view of another side of the composite fabric of FIG. 7A.

### DETAILED DESCRIPTION

The present disclosure can be understood more readily by reference to the following detailed description of the disclosure and the Examples included therein. In various aspects, the present disclosure pertains to a multilayer fabric including at least a first woven fabric layer and a second woven fabric layer tacked to the first woven fabric layer. The first woven fabric layer provides a first functionality to the multilayer fabric, the second woven fabric layer provides a second functionality to the multilayer fabric, and the first functionality is different than the second functionality.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Metalized Fabrics

Fabrics have been functionalized in a number of ways to impart certain properties to, or to enhance and/or support existing properties of, the fabric. These can include functionalization for waterproofing/water resistance, cooling, and antibacterial functionalities. Fabrics have been developed with metal coatings in order to impart certain performance properties to the fabric. It is desirable that these functionalization processes do not negatively affect the structural integrity or properties of the fabric. As an example, such added functionalities may be configured so as to not affect porosity of the material. This is important as porosity of the material may serve a particular function in certain applications. For example, the porosity of a given fabric may govern gas and/or liquid permeation, particulate filtration, and liquid absorption among other properties. Thus, any applied functional treatments that may be intended to further modify the chemical properties of fibers in a fabric are configured not to affect the porosity of the material. Conventionally, this has proven difficult where deposition processes are used to impart functionalization to a given fabric.

The present disclosure achieves improved thermal insulation of particular fabric through surface deposition of a low emissivity material, such as a metal like aluminum for example. Specifically, thermal insulation may be enhanced by combining vapor deposition of a low emissivity material at a woven fabric having a particular yarn denier and weight and particular surface characteristics. Here, a specific base fabric may be metallized at fiber-level through sputtering and/or vapor deposition processes. As provided herein, properties of a base fabric may be maintained in spite of the functionalization processes. These properties may include base material porosity which affects the material's ability to transfer liquid and gaseous molecules, also referred to as element/molecule transfer ability. In further examples, a polymer coating layer may be applied via vapor deposition to improve durability and to prevent oxidation of the low emissivity material. According to various aspects of the present disclosure, the disclosed functionalized fabric may enhanced thermal properties with respect to both maintenance of body heat and reduced solar gain.

Conventional metallized fabrics may achieve insulative properties according to emissivity of the deposited material. However, without being bound to any particular theory, aspects of the present disclosure may establish that neither the emissivity of the metallized fabric nor the emissivity difference between a metallized fabric and an untreated fabric is most indicative of whether a metallized fabric provides enhanced thermal insulation of a fabric, especially when used within an insulation package. In an insulation package, the metallized fabric may be used as an outer shell and/or lining in conjunction with some fibrous insulation.

The microstructure of the disclosed base fabric may contribute to the enhanced thermal insulation phenomenon described above. Microstructure may refer to surface texture of the fabric at the micron scale. Such texture is generally not apparent in other flat surfaces. The flatter the metallized surface, the more directional the reflection of infrared radiation from a heat source. Thus, the insulating ability of the (metallized) fabric may be increased. Disclosed is a metallized textile that provides improved insulative properties when incorporated in an insulative package. Specifically, the insulation package with 60 g/m² sheet insulation and 40D polyester lining fabric may exhibit an enhancement of thermal insulative performance of at least 10% (e.g., 10-25%; 25%; 10% after 10 washes; etc.) when using the metallized textile as shell fabric compared to an untreated shell fabric counterpart when tested according to ASTM F1868.

Sputtering/vapor deposition of the low emissivity material (and coating layer, where applicable) produces a relatively thin coating of reflective material and its coating or protective layer, which is less likely to significantly affect weight, thickness, and handfeel of the metallized fabric. Specifically, functionalization of the disclosed woven fabric via vapor deposition may provide a coating at individual fibers, as opposed to a film or foil adhered to the fabric. Such an individual coating may provide a reflective material and minimize obstruction of gaseous, vapor and/or liquid transfer across the fabric. Thinness of the coating or protective layer may ensure the reflective properties of the low emissivity layer are not obstructed. It also minimizes hindrance of relative movement of fiber to accommodate stretching and mechanical stress of the woven fabric.

As provided herein, the disclosed textile may comprise a woven fabric. A woven fabric may refer to a fabric comprising interlaced filaments, yarns, or fibers. The woven fabric may comprise certain woven fibers. These fabrics may include warp yarns and filling yarns interlaced to provide a consistent fabric surface. These yarns may typically be multifilament, that is, the yarns may comprise multiple filaments. In some examples, the woven fabric may be a plain, ripstop or dobby construction. A plain construction may describe a weave in which wefts alternate over and under warps. A ripstop construction may describe a weave comprised of fiber (such as nylon and/or polyester) reinforcement threads to make it resistant to tearing and ripping. A dobby construction may describe a style of patterned weave having small frequently repeated geometric designs.

In specific aspects, the woven fabric may comprise one or more of a nylon or a polyester. The woven fabric may comprise yarns formed from nylon filament and/or polyester filament. These nylon and polyester yarns may be interlaced to provide the disclosed woven fabric. In further aspects, the woven fabric may comprise an acid, such as a polylactic acid, for example.

Nylon fibers may be formed from nylon resins and may be referred to as polyamide resins. Suitable nylon resins may include nylon-6 (polyamide 6) and nylon-6,6 (polyamide 6,6) which are available from a variety of commercial sources.

The nylon resin may be formed by methods well known to those skilled in the art. Manufacturing processes for preparing the nylon filaments, fibers, or yarns as disclosed herein may include a number of methods, for example, a continuous spin-draw process.

As provided herein, the woven fabric may comprise a polyester. That is, the woven fabric may comprise polyester fibers comprising at least a polyester resin. The polyester resin may comprise polyethylene terephthalate, polybutylene terephthalate, polyethylene naphthalate, polytrimethylene terephthalate (PTT) and mixtures of two or more of the foregoing polymers and/or copolymers. In one example, the woven fabric comprises polyethylene terephthalate or a recycled polyethylene terephthalate.

The polyester resin may be formed by methods well known to those skilled in the art. Manufacturing processes for preparing the polyester filaments, fibers, or yarns as disclosed herein may include a number of methods, for example, a continuous spin-draw process.

The woven fabric may be have a low yarn size and a low weight. That is, the woven fabric have a particular yarn size or thickness and a particular weight. The yarn size of the woven fabric may be less than about 30 denier (30D). For example, the woven fabric may have a yarn size of from about 5D to 30 D, or from about 5 D to about 20D, or from about 5D to 10D.

The woven fabric may be low weight. Specifically, the woven fabric may have a weight of less than 60 grams per square meter (gsm, or g/m²), less than 55 gsm, less than 50 gsm, less than 45 gsm, less than 40 gsm. In some aspects, the woven fabric has a weight from about 30 gsm to about 55 gsm. In some aspects, the woven fabric has a weight from about 30 gsm to about 40 gsm.

As provided herein, surface properties of the woven fabric may affect insulative properties of the disclosed textile. Natural fibers and/or elastane (an elastic polyurethane, commercially available was Spandex or Lycra, for example) may result in rough surface (at micron scale) that diminishes the insulation enhancement through the metallization of fabric. In various examples, the woven fabric may have a surface waviness of less than about 35 micrometers (μm), or less than about 32 μm, when tested in accordance with a Surface Metrology Algorithm Testing System. A low surface roughness, for example less than about 3.3 μm, is desirable. The woven fabric may have a surface roughness of from about 1.5 to 3.3.

A layer of a low emissivity material may be disposed at a surface of the woven fabric. Specifically, a layer of low emissivity material may be disposed at a surface of the woven fabric having a particular surface profile. The surface profile may describe properties of surface roughness and surface waviness. In various aspects of the present disclosure, surface waviness may be characterized by average waviness of a cross-section of the woven fabric. The woven fabric may have an average waviness of less than about 35 μm, or less than about 32 μm, when tested using surface characteristic analysis generated by Surface Metrology Algorithm Testing System (Version: Beta) at Mechanical Metrology Division National Institute of Standards and Technology. Testing for average waviness may be performed with first order least-squares curvature removal and fast Gaussian filter with long cutoff (Lc) of 0.08 mm for the calculation of arithmetic mean roughness (Ra).

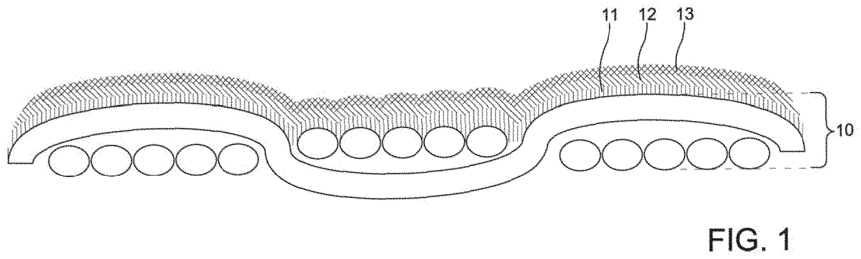

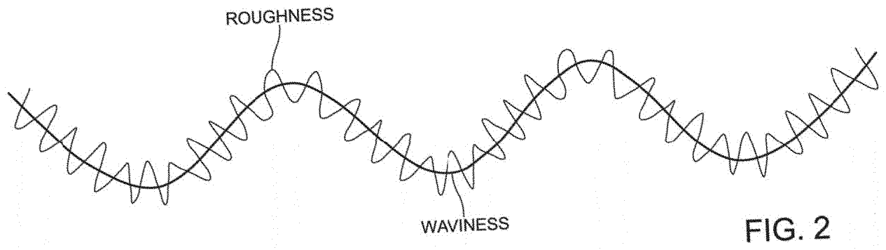

FIG. 1 provides a typical cross-section profile of woven fabric. As shown, a substrate comprising a woven fabric 10 may be coated with an optional polymer undercoating 11, a low emissivity layer 12, and an adjacent polymer coating layer 13. FIG. 2 shows the relationship among surface roughness and waviness. Surface roughness may refer to closely spaced irregularities while surface waviness may describe more widely spaced irregularities. The specified surface roughness and/or surface waviness may allow the low emissivity material to adhere to microstructures at the surface of the woven fabric.

The low emissivity material may be disposed at the woven fabric surface via a process of vapor deposition. Without being bound to any particular theory, vapor deposition may allow for the low emissivity material to adhere to microstructures of the woven fabric. In general, a layer of low emissivity material may be formed using a physical vapor deposition (PVD)/sputtering technique. The low emissivity layer has a thickness of less than 50 nanometers (nm). Vapor deposition may achieve a thickness as thin as few nm with high resolution. For our purpose perhaps 30-70 nm thickness may be appropriate

In various aspects, the low emissivity layer is highly reflective. Emissivity is inversely related to reflectivity for materials that are not transparent to radiation. The metal may exhibit an emissivity of about 0.05 when tested using an emissiometer. The low emissivity layer comprising a metal such as aluminum may provide certain reflective properties. Vapor deposited aluminum may reflect solar radiation thereby reducing heating from the sun. It has been established using simulated solar irradiation (500W halogen lamp) at about 140W/m² directed towards a simulated body (a hotplate) that an aluminum coating on a nylon fabric reduced the amount of simulated solar radiation reaching the simulated body by an amount of about 20% (where aluminum layer configured towards simulated body) and about 38% (where aluminum layer configured towards simulated solar source). Thus, a deposited aluminum layer may prevent excessive heating from solar radiation regardless of direction it is facing (towards body or sun). The effect has been significant even when deposited as a single layer.

It is noted that the greatest warming benefit may be achieved when the reflective material is facing insulation (in an insulated package). Nevertheless, enhanced warmth may be significant regardless of position as long as reflected material is not in direct contact with heat source. Conversely, reduced overheating benefit through reflection of solar radiation can be achieved regardless of position of reflective material, though effect is larger when it is facing the sun.

The low emissivity material may comprise a material having an emissivity of less than 0.2 when tested using an emissometer, such as Model AE1, D&S emissometer. In some examples, the low emissivity material comprises a metal. The low emissivity may comprise aluminum.

The disclosed textile may comprise at least one coating layer. The coating layer may be disposed adjacent the low emissivity layer. As provided herein, the coating layer may provide a protective layer for the fabric and low emissivity layer thereby preventing metal oxidation and improving durability. In some examples, the coating layer may be disposed between the woven fabric and the low emissivity layer, which may improve or facilitate adhesion low emissivity layer and a surface of the woven fabric.

The coating layer may be disposed adjacent the low emissivity layer via a process of vapor deposition, such as, for example, chemical vapor deposition. Vapor deposition may ensure thinness of the coating layer such that reflective properties of the low emissivity layer are maintained. In yet further examples, a coating layer may be disposed between the woven fabric and the low emissivity layer.

The coating layer may comprise a polymer. Suitable polymers for the coating layer may include a polyacrylate, a polyurethane, a polyester, a silicone, or a combination thereof. In one example, the coating layer may comprise an acrylic polymer. The coating layer may have a thickness of fewer than 400 nm. The coating layer may be disposed via vapor deposition.

It may be desirable in some aspects to apply a final finishing treatment to only one layer of the metallized textile or garment incorporating it. For example, the textile comprising the woven fabric, low emissivity layer, and coating layer may be treated with a durable water repellent (DWR) finish that may be adjacent the woven fabric. In some examples however, the textile is free of or substantially free of a chemical finish. As a specific example, the disclosed textile is free of or substantially free of a chemical finish such as a water repellant. In further aspects however, the disclosed textile may include a chemical finish such as a water repellant finish. A DWR may exhibit a minimal effect on the thermal performance. That is, the fabric may achieve at least 10% (e.g., 10-25%; 25%; 10% after 10 washes; etc.) of insulation enhancement so long as the base fabric satisfies the denier/weight and fiber type requirement described herein even in the presence of the DWR finish.

The textile may include a mechanical finish. A suitable mechanical finish may include a ciré. A ciré may describe a glazed wax finish that may be applied to a fabric through a process of heat and pressure. The mechanical finish may be disposed adjacent the coating layer.

### Methods for Forming a Metallized Textile

Aspects of the disclosure further relate to methods for forming the textile and woven fabric comprised thereof. The woven fabric may be formed via any suitable process well known in the art. Formation of the metallized textile may include vapor deposition of a low emissivity layer at a surface of the woven fabric. The woven fabric may be metallized via a process of chemical or physical vapor deposition as described herein.

The disclosed textile may be formed according to the methods described herein and may have any of the functionalities, yarns, yarn types, yarn sizes, yarn colors, fabric constructions, weave types, and optional additional woven fabric layers as described above, and are not repeated herein.

If patterning of aluminum and/or exposure of a base woven fabric is desired, such as for aesthetic and/or functionality purposes, sputtering may be performed with a shadow mask.

Articles Formed from the Metallized Fabric

Metallized fabrics according to aspects described herein and formed according to methods described herein may be useful in a wide range of applications. The metallized fabrics may be particularly useful in garments as work wear, outerwear, outdoor applications, casual wear, fashion wear, personal protective equipment, and as specialty equipment. In some aspects, garments formed from the disclosed textile include a jacket, pants, jeans, hat, a shirt, an overall, workwear, or active wear. In one example, at least a portion of a garment may comprise the metallized textile as described herein.

### Properties

The disclosed textiles provide increased thermal insulation via surface deposition of a low emissivity material at a certain woven fabric. The woven fabric is metallized at fiber-level through sputtering and/or vapor deposition process to maintain base material porosity and element/molecule transfer ability. The thermal insulation includes both retaining body heat and reducing solar gain. The textile may exhibit an increase in insulation ability of at least 10% (e.g., 10-25%; 25%; 10% after 10 washes; etc.) compared to a substantially similar woven fabric in the absence of the low emissivity layer when tested in accordance with ASTM-F1868 Part A. Substantially similar woven fabric, as used herein, may reference a woven fabric consisting essentially of the same components, but in the absence of the low emissivity layer. Further, the disclosed textile may exhibit an emissivity difference of at least 0.3 compared to a substantially similar woven fabric in the absence of the vapor deposited layer when tested by emissometer. In some examples, the disclosed textile may exhibit an emissivity difference of at least 0.35 compared to a substantially similar woven fabric in the absence of the vapor deposited layer when tested by emissometer.

The positioning of the metallized fabric in a given garment may affect any insulative benefit. The metal coated woven fabric may be used as shell and/or lining in conjunction with fibrous insulation. For example, the metallized fabric may be in direct contact with heat source (or body), that is the metallized fabric may be the fabric layer of an insulative package that is closest to the body heat such as the lining. In other examples, the metallized fabric may be the outermost fabric layer of the insulative package such as the shell.

Reflective properties of the low emissivity layer may provide further benefits for a user of a garment comprising the disclosed textile. The disclosed low emissivity layer, for example a metal such as aluminum, may reflect solar radiation to reduce heating from the sun. In one example where a simulated sun (for example, a 500 watt (W) halogen lamp) provides about 140W/m² (watts per square meter) of heat energy to a simulated body (a hotplate), an aluminum coating on thin nylon fabric reduces the amount of simulated solar radiation reaching the plate by about 20% (when the aluminum coating is facing the hotplate) and by about 38% (when the aluminum coating is facing the lamp) of Thus, the metallized fabric may prevent or reduce excessive heating from solar radiation regardless of direction it is facing (towards body or sun). Such an effect may be observed even when the metallized fabric is used as single layer.

As a further example, a user may experience enhanced UV protection. A user may also experience increased subcutaneous oxygen, as well as potential radio frequency shielding.

### Composite Fabrics Including a First Fabric Layer and Insulating Structures

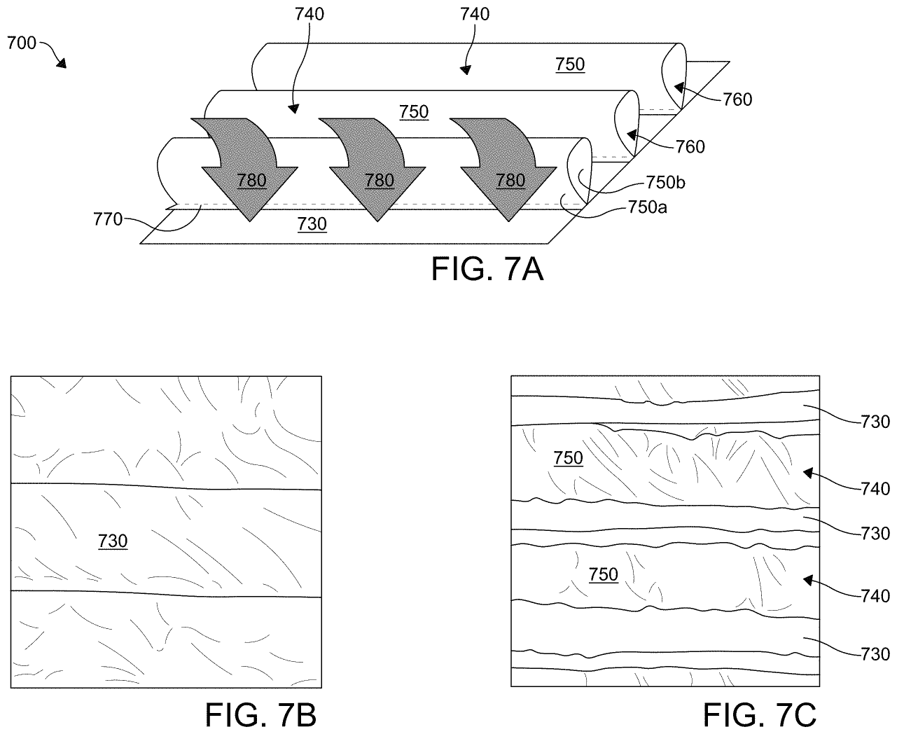

With reference to FIGS. 7A-7C, aspects of the disclosure relate to a composite fabric 700 including a first fabric layer 730 and a plurality of insulating structures 740 adjacent to the first fabric layer 730. In some aspects each of the plurality of insulating structures 740 include a fabric shell 750 defining a cavity 760 and an insulating material (not shown) located within the cavity 760.

The first fabric layer 730 may be located on either side of a fabric and/or a garment formed therefrom. For example, in some aspects the first fabric layer 730 is located on a body side of the composite fabric 700, i.e., the side of the fabric facing towards the body of a user. In other aspects the first fabric layer 730 is located on a face side of the composite fabric 700, i.e., the side of the fabric facing away from the body of the user. In certain aspects the composite fabric 700 is reversible such that a user of the fabric (e.g., a wearer of a garment including the composite fabric 700) could use the composite fabric with the first fabric layer 730 facing towards the user or away from the user. Also as used herein, “adjacent” means on or in proximity to and does not foreclose intervening components, including additional fabric layer(s), air or fluid.

With reference to FIG. 7A-7C, in some aspects each of the plurality of insulating structures 740 are attached to the first fabric layer 730. In particular aspects each of the plurality of insulating structures 740 are stitched 770 to the first fabric layer (bottom of insulating structure 740 shown as stitched directly to the first fabric layer 730. The plurality of insulating structures 740 could be attached to the first fabric layer 730 by any suitable method, such as with an adhesive, sewn, knit, welded or stitched.

The plurality of insulating structures 740 shown in FIGS. 7A-7C may in some aspects be loosely attached (or stitched 770) to the first fabric layer 730 such that they are free to move. When the fabric is used (e.g., worn), the plurality of insulating structures may lay down against the first fabric layer 730 (illustrated by the arrows 780), forming a warm insulating layer in the composite fabric 700.

The first fabric layer 730 may have any suitable fabric construction. In some aspects the first fabric layer 730 is a woven fabric. In other aspects the first fabric layer 730 is a knit fabric, a nonwoven fabric or a laminate fabric. In particular aspects the first fabric layer 730 includes taffeta, although any other suitable fabric material may be used, including but not limited to cotton, wool, nylon, polyester and combinations thereof.

In certain aspects the first fabric layer 730 is highly breathable, or air permeable. Air permeability may be determined in accordance with ASTM D737, and is reported in cubic feet per minute (CFM). In some aspects the first fabric layer 730 has an air permeability of from about 30 CFM to about 100 CFM when tested in accordance with ASTM D737. In some aspects the first fabric layer 730 has an air permeability of from about 40 CFM to about 80 CFM when tested in accordance with ASTM D737. In particular aspects the first fabric layer 730 has an air permeability of from about 50 CFM to about 60 CFM when tested in accordance with ASTM D737. The high air permeability of the first fabric layer 730 provides a breathable layer to the composite fabric 700 that allows moisture to pass therethrough.

The fabric shell 750 can have any suitable fabric construction. In some aspects the fabric shell 750 is a woven fabric, a knit fabric, a nonwoven fabric or a laminate fabric. In particular aspects the fabric shell 750 includes taffeta, although any other suitable fabric material may be used, including but not limited to cotton, wool, polyester, nylon and combinations thereof. The fabric shell 750 may define a baffle layer having an exterior surface 750a and an interior surface 750b. One of more of the surfaces 750a, 750b may comprise a low emissivity layer, such as a layer of material deposited thereon using vapor deposition, for example. The low emissivity layer increases the clo/insulation of the composite fabric compared to a substantially similar composite fabric in the absence of the low emissivity layer when tested in accordance with ASTM-F1868 Part A.

It may be desirable in some aspects for the fabric shell 750 to be substantially impermeable to air or to have a very low permeability. In particular aspects the fabric shell 750 has an air permeability of from 0 CFM to about 5 CFM when tested in accordance with ASTM D737. The fabric shell 750 may be downproof for natural down or synthetic down. The fabric shell 750 has an air permeability of from 0.5 CFM to about 8 CFM when tested in accordance with ASTM D737, which may define a downproof spec for synthetic down. The fabric shell 750 has an air permeability of from 0.5 CFM to about 5 CFM when tested in accordance with ASTM D737, which may define a downproof spec for natural down. In further aspects the fabric shell 750 has an air permeability of from 0 CFM to about 2 CFM when tested in accordance with ASTM D737. The use of an impermeable or substantially impermeable fabric for the fabric shell 750 provides warmth to the fabric and encapsulates the insulating material in the cavity 760 to prevent or minimize migration or movement of the insulating material within the composite fabric 700.

As noted, each of the plurality of insulating structures 740 include a fabric shell 750 defining a cavity 760 and an insulating material located within the cavity 760. Any suitable insulating material can be used, including a natural insulation material, a synthetic insulation material, or a combination thereof. In particular aspects the insulating material includes at least one natural insulating material, including down (e.g., goose or duck plumage). Other natural insulating materials that could be used in the composite fabric 700 include, but are not limited to, cotton and wool. In further aspects the insulating material includes at least one synthetic insulating material, including polyester. Other synthetic insulating materials that could be used in the composite fabric 700 include, but are not limited to, PrimaLoft®, Thinsulate™, Thermolite®, Quallofil®, ThermoBall™, polyethylene terephthalate, polypropylene, acrylic and combinations thereof. The insulating material may be inserted into the cavity by any conventional process, including but not limited to air blowing, insertion, injection, and rapier insertion. In addition, the insulating material may be in any form. In some aspects the insulating material is a loose fiber; in other aspects the insulating material is shaped (e.g., in a tubular form).

Various combinations of elements of this disclosure are encompassed by this disclosure, e.g., combinations of elements from dependent claims that depend upon the same independent claim.

### Aspects of the Disclosure

In various aspects, the present disclosure pertains to and includes at least the following aspects.

Aspect 1. A textile comprising: a woven fabric comprising one or more of a nylon or a polyester, wherein the woven fabric has a yarn size of no greater than 30D, a weight no greater than 40 gsm, and a surface waviness of less than about 35 μm, or less than about 32 μm, when tested in accordance with a Surface Metrology Algorithm Testing System; a layer of a low emissivity material disposed on the woven fabric, wherein the layer of low emissivity material is vapor deposited; and at least one coating layer vapor deposited adjacent the low emissivity layer, wherein the textile exhibits an increase in insulation ability of at least 10% (e.g., 10-25%; 25%; 10% after 10 washes; etc.) compared to a substantially similar woven fabric in the absence of the layer of low emissivity material when tested together with a fibrous sheet insulation and another untreated woven fabric in accordance with ASTM-F1868 Part A.

Aspect 2. A textile comprising: a woven fabric comprising one or more of a nylon or a polyester, wherein the woven fabric has a surface waviness of less than about 32 μm, when tested in accordance with a Surface Metrology Algorithm Testing System, wherein the layer of low emissivity material is vapor deposited; and at least one coating layer vapor deposited adjacent the low emissivity layer, wherein the textile exhibits an increase in insulation ability of at least 10% (e.g., 10-25%; 25%; 10% after 10 washes; etc.) compared to a substantially similar woven fabric in the absence of the layer of low emissivity material when tested together with a fibrous sheet insulation and another untreated woven fabric in accordance with ASTM-F1868 Part A.

Aspect 3. A textile comprising: a woven fabric comprising one or more of a nylon or a polyester, wherein the woven fabric has a yarn size of no greater than 30D and a weight no greater than 40 gsm; a layer of a low emissivity material disposed on the woven fabric, wherein the layer of low emissivity material is vapor deposited; and at least one coating layer vapor deposited adjacent the low emissivity layer, wherein the textile exhibits an increase in insulation ability of at least 10% (e.g., 10-25%; 25%; 10% after 10 washes; etc.) compared to a substantially similar woven fabric in the absence of the layer of low emissivity material when tested together with a fibrous sheet insulation and another untreated woven fabric in accordance with ASTM-F1868 Part A.

Aspect 4. The textile of any of aspects 1-3, wherein the woven fabric has a surface waviness of less than about 32 μm, when tested in accordance with a Surface Metrology Algorithm Testing System.

Aspect 5. The textile of any of aspects 1-4, wherein the textile exhibits an emissivity difference of at least 0.25 compared to a substantially similar woven fabric in the absence of the vapor deposited layer when tested by emissometer.

Aspect 6. The textile of any of aspects 1-5, wherein the woven fabric has a weight from 30 gsm to 40 gsm.

Aspect 7. The textile of any of aspects 1-5, wherein the woven fabric has a weight less than 40 gsm.

Aspect 8. The textile of any of aspects 1-7, wherein the woven fabric has a yarn denier size from 15D to 20D.

Aspect 9. The textile of any of aspects 1-7, wherein the woven fabric has a yarn denier size from 5D to 10D.

Aspect 10. The textile of any of aspects 1-7, wherein the woven fabric has a yarn denier size from 5D to 30D.

Aspect 11. The textile of any of aspects 1-10, wherein the coating layer comprises an acrylic polymer.

Aspect 12. The textile of any of aspects 1-11, wherein the coating layer comprises a polyacrylate, polyurethane, polyester, silicone, or a combination thereof.

Aspect 13. The textile of any of aspects 1-11, wherein the coating layer comprises a polyacrylate, polyurethane, polyester, silicone, or a combination thereof.

Aspect 14. The textile of any of aspects 1-13, wherein the coating layer has a thickness of less than 400 nm.

Aspect 15. The textile of any of aspects 1-14, wherein the layer of low emissivity material has a thickness of less than 50 nm.

Aspect 16. The textile of any of aspects 1-15, wherein the low emissivity material comprises a metal.

Aspect 17. The textile of any of aspects 1-16, wherein the low emissivity material has an emissivity below 0.2 when tested using an emissometer.

Aspect 18. The textile of any of aspects 1-17, wherein the metal comprises aluminum.

Aspect 19. The textile of any of aspects 1-18, wherein the coating layer is disposed via vapor deposition.

Aspect 20. The textile of any of aspects 1-19, wherein the low emissivity layer adheres to microstructures of a surface of the woven fabric.

Aspect 21. The textile of any of aspects 1-20, wherein the nylon comprises nylon 6, nylon 6,6, or a combination thereof.

Aspect 22. The textile of any of aspects 1-21, wherein the polyester comprises polyethylene terephthalate, recycled polyethylene terephthalate.

Aspect 23. The textile of any of aspects 1-22, further comprising a mechanical finish.

Aspect 24. The textile of any of aspects 1-23, wherein the textile is free of a chemical finish.

Aspect 25. A garment, wherein at least a portion of the garment comprises the textile according to any of aspects 1-24.

Aspect 26. An insulative garment comprising: a fabric layer comprising one or more of a nylon and a polyester, wherein the fabric layer has a yarn size no greater than 30D and a weight no greater than 40 gsm; a coating layer disposed adjacent the fabric layer; and a low emissivity layer disposed between the fabric layer and the coating layer, wherein the layer of low emissivity material is disposed via a vapor deposition process.

Aspect 27. The insulative garment of aspect 26, wherein the coating layer comprises an acrylic polymer.

Aspect 28. The insulative garment of any of aspects 26-27, wherein the layer of low emissivity material comprises a metal.

Aspect 29. A composite fabric comprising: a first fabric layer, wherein the first fabric layer comprises a woven fabric or a knit fabric, and wherein the first fabric layer has an air permeability of from about 30 cubic feet per minute (CFM) to about 100 CFM when tested in accordance with ASTM D737; a plurality of insulating baffle structures disposed adjacent the first fabric layer, each of the plurality of insulating baffle structures comprising a fabric shell defining a cavity and an insulating material located within the cavity, wherein the fabric shell is downproof, having an air permeability of from 0.5 CFM to about 8 CFM when tested in accordance with ASTM D737; and a low emissivity layer disposed on a surface of the fabric shell, wherein the low emissivity layer is disposed via a vapor deposition process, and wherein the low emissivity layer increases the insulation of the composite fabric compared to a substantially similar composite fabric in the absence of the low emissivity layer when measured in accordance with ASTM-F1868 Part A.

The composite fabric of aspect 29, wherein the low emissivity layer comprises a metal.

The composite fabric of aspect 29, wherein the insulation of the composite fabric is increased by at least 5%, at least 6%, at least 7%, at least 8%, at least 9%, or at least 10%.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims that follow, reference will be made to a number of terms that shall be defined herein.

As used in the specification and the appended claims, the singular forms “a,” “an” and “the” include plural referents unless the context clearly dictates otherwise. Thus, for example, reference to “a fiber” includes mixtures of two or more fibers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, “textile” may refer to a flexible material consisting of a network of natural or artificial fibers. A textile may comprise woven fibers. Fabric, as used herein, is related to textile and may refer to a material made through weaving, knitting, spreading, crocheting, or bonding that may be used in production of further goods. Cloth may be used synonymously with fabric but is often a piece of fabric that has been processed.

As used herein, “garment” means an item of clothing wherein the fabric that makes up the garment has been assembled into the garment, e.g., a pair of pants or a jacket, such that the garment is ready to wear. It should be understood that a “garment” for purposes of the present disclosure need not be fully complete and can be missing one or more ornamental features (e.g., rhinestones), closures (e.g., buttons), or other features that can be comprising on or in the garment when the garment is offered for sale to consumers. It should be understood that the term “garment” is not limited to any particular type of clothing article and can include, e.g., pants, shirts, jackets, robes, dresses, formal wear, business wear, athletic apparel, leisure wear, footwear, outerwear, intimates, and the like.

An insulation package may describe a combination of materials used for insulative purposes, particularly in an apparel context. Here, the insulation package may describe the woven fabric used as an outer shell and/or lining in conjunction with some fibrous insulation. The fibrous insulation may be synthetic materials (such as polyester fibers, for example) or natural materials (such as, goose down for example) and may exist in various forms such as batt/sheet, ball or loose fiber, for example. As a lining, the woven fabric may be closer to the user of the woven fabric or to a wearer of a garment comprising the woven fabric.

As used herein, the terms “optional” or “optionally” means that the subsequently described event or circumstance can or cannot occur, and that the description includes instances where said event or circumstance occurs and instances where it does not. For example, the phrase “optional additional woven fabric layers” means that the additional woven fabric layer(s) can or cannot be included and that the disclosure includes multilayer fabrics that both include and that do not include additional woven fabric layer(s).

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions.

Disclosed herein are certain structural requirements for performing the disclosed functions and it is understood that there are a variety of structures that can perform the same function that are related to the disclosed structures, and that these structures will typically achieve the same result.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for.

### Example 1—Forming the Metallized Fabric

Metallization of the disclosed woven fabric may proceed by flash evaporation of a monomer and its subsequent polymerization by radiation curing in a vacuum chamber, a polymer layer is first deposited to produce a smooth thin layer over the fibers and a metal layer is then deposited over the resulting improved substrate. A suitable process is described in U.S. Pat. No. 7,157,117.

### Example 2—Evaluating Warmth Benefit of the Metallized Fabric

The warmth benefit of a fabric according to the present disclosure was tested on Sweating Guarded Hotplate (Thermetrics Serial #306-4XX) using a modified method according to ASTM-F1868 Part A, where plate & guard temperature are 35° C.; air velocity, 1 m/s; ambient temperature, 20° C.; ambient relative humidity, 40RH %; and ambient lighting, dark (room lighting turned off).

At least four different combinations of control uncoated nylon/polyester, aluminum coated nylon/polyester and polyester sheet insulation (60 g/m²) were tested. Samples at 20 inch by 20 inch (50.8 cm by 50.8 cm) sizes were pinned together with sheet insulation in between various versions of nylon/polyester fabric. Steady state reading (typically longer than 20 minutes) were recorded for comparison.

### Example 2—Conventional Metallized Fabric

Conventional metallized flat substrate such as film achieve insulative properties according to emissivity of the deposited material. However, aspects of the present disclosure establish neither the emissivity of the metallized fabric nor the emissivity difference between a metallized fabric and an untreated fabric is most indicative of whether a metallized fabric provides enhanced thermal insulation of fabric, especially when used within an insulation package.

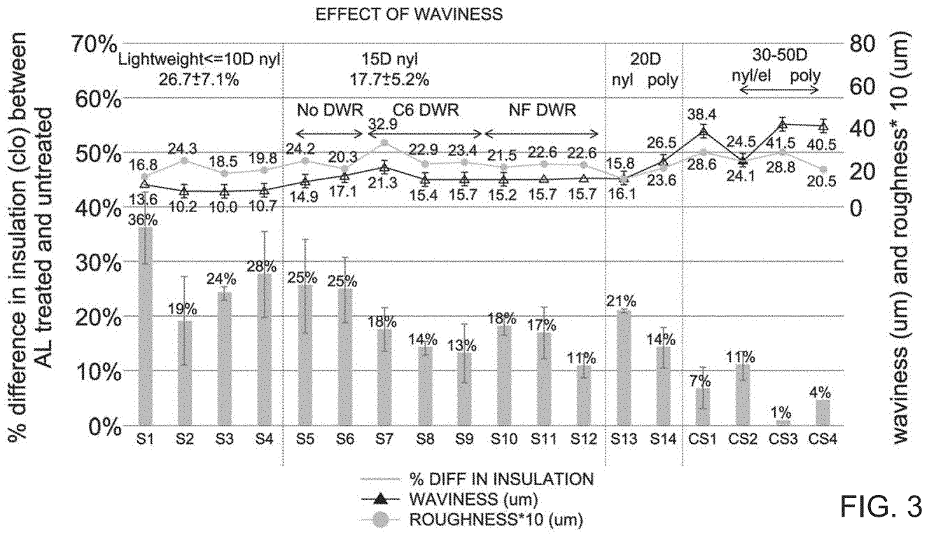

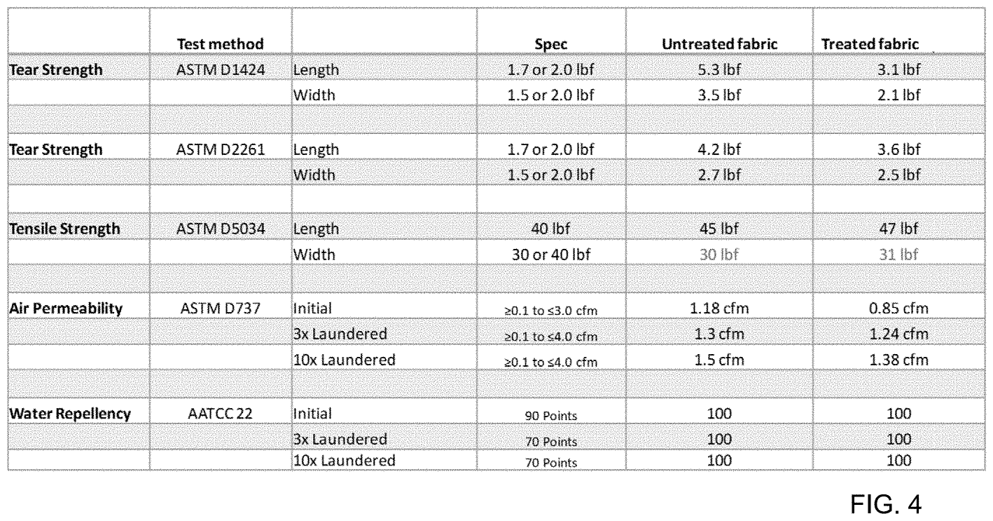

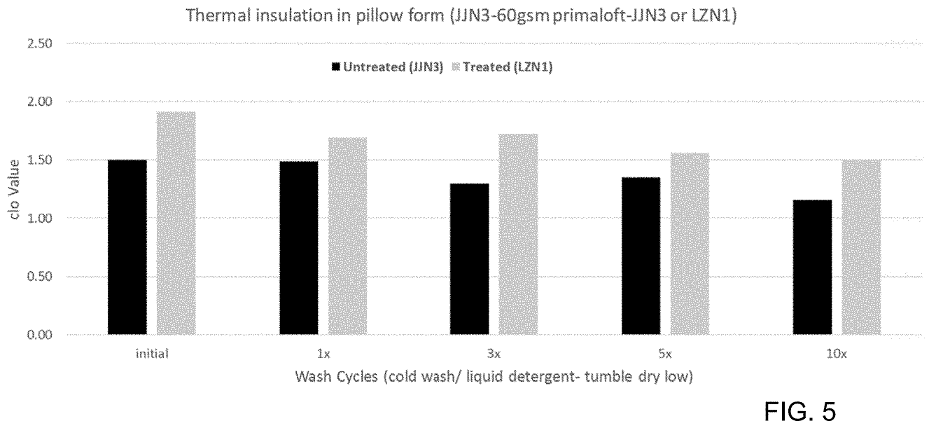

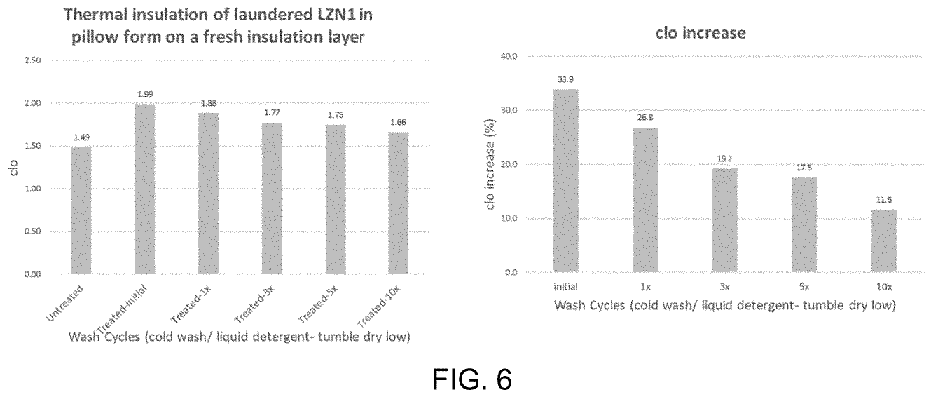

FIG. 3 demonstrates the effect of waviness of the disclosed woven fabric compared to other woven fabrics on the percent difference in insulation. As shown, the disclosed woven fabrics having a waviness of less than about 35 μm may provide a thermal enhancement of about 10% (e.g., 10-25%; 25%; 10% after 10 washes; etc.). Samples S1 through S4 comprise lightweight (less than 10D nylon woven fabric); S5 through S12 comprise 15D nylon; and S13 and S14 comprise 20D nylon and polyester woven fabric, respectively. These fabrics may have a weight less than 30D (samples S1 through S14) to provide a percent difference in insulation of at least 11%. Comparative samples CS1 through CS4 comprise 30-50D nylon/elastane or polyester woven fabrics. CS1 through C4, having a higher denier weight (greater than 30D) and/or higher waviness (greater than 35), exhibited lower percent differences in insulation than inventive samples S1 through S14.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

While typical aspects have been set forth for the purpose of illustration, the foregoing descriptions should not be deemed a limitation on the scope herein. Accordingly, various modifications, adaptations, and alternatives can occur to one skilled in the art without departing from the spirit and scope herein.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A textile comprising:
a woven fabric comprising one or more of a nylon or a polyester, wherein the woven fabric has a yarn size of no greater than 30D and a weight no greater than 55 gsm;
a layer of a low emissivity material disposed on the woven fabric, wherein the layer of low emissivity material is vapor deposited; and
at least one coating layer vapor deposited adjacent the low emissivity layer,
wherein the textile exhibits an increase in insulation ability of at least 10% compared to a substantially similar woven fabric in the absence of the low emissivity layer when tested together with a fibrous sheet insulation and another untreated woven fabric in accordance with ASTM-F1868 Part A.

2. The textile of claim 1, wherein the textile exhibits an emissivity difference of at least 0.25 compared to a substantially similar woven fabric in the absence of the layer of low emissivity material when tested by emissometer.

3. The textile of claim 1, wherein the woven fabric has a surface waviness of less than about 35 μm, when tested in accordance with a Surface Metrology Algorithm Testing System.

4. The textile of claim 1, wherein the woven fabric has a yarn denier size from 5D to 30D.

5. The textile of claim 1, wherein the at least one coating layer comprises a polyacrylate, polyurethane, polyester, silicone, or a combination thereof.

6. The textile of claim 1, wherein the coating layer has a thickness of less than 400 nm.

7. The textile of claim 1, wherein the layer of low emissivity material has a thickness of less than 50 nm.

8. The textile of claim 1, wherein the low emissivity material comprises a metal.

9. The textile of claim 1, wherein the low emissivity material has an emissivity of 0.2 when tested using an emissometer.

10. The textile of claim 1, wherein the metal comprises aluminum.

11. The textile of claim 1, wherein the coating layer is disposed via vapor deposition.

12. The textile of claim 1, wherein the layer of low emissivity material adheres to microstructures of a surface of the woven fabric.

13. The textile of claim 1, wherein the nylon comprises nylon 6, nylon 6,6, or a combination thereof.

14. The textile of claim 1, wherein the polyester comprises polyethylene terephthalate, recycled polyethylene terephthalate.

15. The textile of claim 1, further comprising a mechanical finish.

16. The textile of claim 1, wherein the textile is free of a chemical finish.

17. A textile comprising:
a woven fabric comprising one or more of a nylon or a polyester, wherein the woven fabric has a surface waviness of less than about 35 μm, when tested in accordance with a Surface Metrology Algorithm Testing System;
a layer of a low emissivity material disposed on the woven fabric, wherein the layer of low emissivity material is vapor deposited; and
at least one coating layer vapor deposited adjacent the low emissivity layer,
wherein the textile exhibits an increase in insulation ability of at least 10% compared to a substantially similar woven fabric in the absence of the layer of low emissivity material when tested together with a fibrous sheet insulation and another untreated woven fabric in accordance with ASTM-F1868 Part A.

18. A garment, wherein at least a portion of the garment comprises the textile according to claim 17.

19. A composite fabric comprising:
a first fabric layer, wherein the first fabric layer comprises a woven fabric or a knit fabric, and wherein the first fabric layer has an air permeability of from about 30 cubic feet per minute (CFM) to about 100 CFM when tested in accordance with ASTM D737;
a plurality of insulating baffle structures disposed adjacent the first fabric layer, each of the plurality of insulating baffle structures comprising a fabric shell defining a cavity and an insulating material located within the cavity, wherein the fabric shell is downproof, having an air permeability of from 0.5 CFM to about 8 CFM when tested in accordance with ASTM D737; and
a low emissivity layer disposed on a surface of the fabric shell, wherein the low emissivity layer is disposed via a vapor deposition process, and wherein the low emissivity layer increases the insulation of the composite fabric compared to a substantially similar composite fabric in the absence of the low emissivity layer when measured in accordance with ASTM-F1868 Part A.

20. The composite fabric of claim 19, wherein the low emissivity layer comprises a metal.
